(19) United States
(12) Patent Application Publication
(10) Pub. No.: US 2012/0320399 A1
(43) Pub. Date: Dec. 20, 2012

(54) IMAGE FORMING APPARATUS, IMAGE FORMING SYSTEM, AND POST-PROCESSING APPARATUS WHICH PERFORM SKEW FEEDING CORRECTION

(75) Inventor: Naoka Omura, Matsudo-shi (JP)

(73) Assignee: CANON KABUSHIKI KAISHA, Tokyo (JP)

(21) Appl. No.: 13/517,669

(22) Filed: Jun. 14, 2012

(30) Foreign Application Priority Data
Jun. 16, 2011 (JP) 2011-134303
May 31, 2012 (JP) 2012-124394

(51) Int. Cl. G06K 15/02

(52) U.S. Cl. 358/1.13

(57) ABSTRACT

An image forming apparatus that performs accurate skew feeding correction of a sheet by taking into account the difference between the amounts of expansion or contraction of the sheet subjected to fixing processing between positions in the lateral direction. A transfer section transfers an image onto a sheet. An image pickup unit acquires first information on the skew of a leading end of the sheet. A correction unit corrects the attitude of the sheet based on the first information. A fixing device fixes the image transferred onto the sheet. An inversion path inverts the sheet upside down. Another image pickup unit acquires second information on the skew of an end of the sheet. Before transferring an image onto a second surface of the sheet, the correction unit corrects the attitude of the sheet based on the second information and the first information.

### BACKGROUND OF THE INVENTION

1. Field of the Invention

The present invention relates to an image forming apparatus that employs an electrophotographic method or an electrostatic recording method, a post-processing apparatus that performs post-processing on a sheet having an image formed thereon, and an image forming system including the image forming apparatus and the post-processing apparatus, and more particularly to a technique for correcting skew feeding of a sheet.

2. Description of the Related Art

As one method of correcting skew feeding of a sheet in an image forming apparatus, an active registration method is known which corrects skew feeding of a sheet while conveying the sheet. In this method, two sensors are arranged in a sheet conveying path at respective locations spaced in a direction orthogonal to the sheet conveying direction by a predetermined distance, and a skew of the sheet is detected based on signals each indicating that a leading edge of the sheet has crossed an associated one of the sensors. Then, two skew correction rollers, the rotational speeds of which can be controlled independently of each other, are arranged on the same axis in the direction orthogonal to the sheet conveying direction in a manner spaced from each other by a predetermined distance, and the conveying speeds of the sheet determined by rotational speeds of the two skew correction rollers is controlled, whereby the skew feeding of the sheet is corrected (see Japanese Patent Laid-Open Publication No. H10-032682).

When images are formed on both surfaces of the sheet, an image is transferred onto a first surface of the sheet, and then the sheet is conveyed to a fixing device including a heating roller and a pressure roller. In the fixing device, the sheet is heated by the heating roller as it is passed through a nip formed between a heating roller and a pressure roller, whereby the image is fixed on the sheet. After the image is fixed on the first surface of the sheet, an image is transferred onto a second surface of the sheet, and the sheet is conveyed to the fixing device again. This also fixes an image on the second surface of the sheet.

Further, when post-processing is performed on a sheet, the sheet, after having passed through the fixing device, is conveyed to a post-processing apparatus, where desired post-processing is performed on the sheet.

However, if the axial direction of the heating roller and that of the pressure roller are not parallel to each other, the distribution of pressure in the nip ceases to be uniform in the axial direction of the pressure roller. As a consequence, the amount of expansion or contraction of the sheet varies with a position on the sheet in the direction of width thereof, whereby the leading and trailing edges of the sheet sometimes cease to be orthogonal to the lateral edges of the sheet. In the conventional technique, such expansion or contraction of the sheet is not taken into account, so that excessive skew feeding correction is sometimes executed when an image is formed on the second surface of the sheet having passed through the fixing device. Hereinafter, a description will be given of this excessive skew feeding correction.

FIG. 7A illustrates a state of a sheet before it is passed through the fixing device. FIG. 7B illustrates a state of a sheet after it has passed through the fixing device. More specifically, FIG. 7B illustrates a state in which a skew α is produced at a leading edge of the sheet after the fixing processing. Now, a description will be given of a method of correcting the skew α of a sheet by the active registration method, after the skew α is produced at the leading edge of the sheet.

FIG. 8 schematically shows how skew feeding correction processing is performed on a sheet. In the illustrated example, a skew β of a leading edge of a sheet P is detected based on signals each indicating that the leading edge of the sheet P has crossed an associated one of sheet detection sensors 133 and 134, and the skew of the sheet P is corrected by controlling the rotational speeds of respective skew correction rollers 141 and 142 such that the skew β becomes equal to 0.

FIG. 9 illustrates an attitude (broken line) of the sheet P before the skew correction rollers 141 and 142 corrects the skew feeding of the sheet P, and an attitude (solid line) of the sheet P after the skew correction rollers 141 and 142 has corrected the skew feeding of the sheet P. Since the skew correction rollers 141 and 142 are controlled such that the skew β of the sheet P detected by the sheet detection sensors 133 and 134 becomes equal to 0, the sheet P does not assume a correct attitude.

### SUMMARY OF THE INVENTION

The present invention provides an image forming apparatus that performs accurate skew feeding correction of a sheet by taking into account differences in the amount of expansion or contraction of the sheet after being subjected to fixing processing between positions on the sheet in the direction of width thereof.

In a first aspect of the present invention, there is provided an image forming apparatus comprising a transfer unit configured to transfer an image onto a sheet, a first acquisition unit configured to acquire first information on a skew of a leading end of the sheet at a first position upstream of the transfer unit in a sheet conveying direction, a correction unit configured to correct an attitude of the sheet based on the first information acquired by the first acquisition unit, a fixing unit configured to fix an image transferred onto the sheet by the transfer unit, on the sheet, an inversion unit configured to invert, after an image is fixed on a first surface of a sheet by the fixing unit, the sheet upside down in order to transfer an image onto a second surface of the sheet, and a second acquisition unit configured to acquire second information on a skew of an end of the sheet at a second position downstream of the fixing unit in the sheet conveying direction, the end of the sheet being the leading end of the sheet after the sheet is inverted upside down by the inversion unit, wherein when an image is transferred onto the second surface of a sheet, the correction unit corrects an attitude of the sheet based on the second information acquired by the second acquisition unit, and the first information, acquired by the first acquisition unit, on a skew of a leading end of the sheet which has been inverted upside down by the inversion unit.

In a second aspect of the present invention, there is provided an image forming system comprising a transfer unit configured to transfer an image onto a sheet, a fixing unit configured to fix the image transferred onto the sheet by the transfer unit on the sheet, a post-processing unit configured to perform post-processing on the sheet after the image is fixed on the sheet by the fixing unit, a first acquisition unit configured to acquire first information on a skew of a leading end of the sheet having passed the fixing unit, at a first position downstream of the fixing unit and upstream of the post-processing unit in a sheet conveying direction, a second acquisition unit configured to acquire second information on the skew of the leading end of the sheet at a second position downstream of the first position and upstream of the post-processing unit in the sheet conveying direction, and a correction unit configured to correct an attitude of the sheet based on the first information acquired by the first acquisition unit and the second information acquired by the second acquisition unit.

In a third aspect of the present invention, there is provided a post-processing apparatus that performs post-processing on a sheet on which an image has been formed by an image forming apparatus, comprising a reception unit configured to receive first information transmitted from the image forming apparatus including a fixing unit configured to fix an image formed on a sheet, on the sheet, the first information being information on a skew of a leading end of the sheet on which the image has been fixed by the fixing unit, a post-processing unit configured to perform post-processing on the sheet supplied from the image forming apparatus, an acquisition unit configured to acquire second information on a skew of the leading end of the sheet supplied from the image forming apparatus, at a position upstream of the post-processing unit, a correction unit configured to correct an attitude of the sheet based on the first information received by the reception unit and the second information acquired by the acquisition unit.

According to the present invention, it is possible to perform accurate skew feeding correction of a sheet by taking into account the expansion or contraction of the sheet subjected to fixing processing. This makes it possible to obtain a high-quality post-processed product in a case where post-processing is performed on a printed sheet, and also make it possible to perform accurate printing on a sheet without displacement of an image with respect to the sheet in a case where a second surface of the sheet is printed.

Further, features of the present invention will become apparent from the following description of exemplary embodiments with reference to the attached drawings.

### BRIEF DESCRIPTION OF THE DRAWINGS

FIG. 1 is a schematic cross-sectional view of an image forming system according to an embodiment of the present invention.

FIG. 2 is a schematic plan view of a sheet having passed a fixing device and a sheet detection sensor in the image forming system in FIG. 1.

FIG. 3 is a block diagram of a control system of the image forming system in FIG. 1.

FIG. 4 is a flowchart of a printing process executed by an image forming apparatus that constitutes the image forming system in FIG. 1.

FIG. 5 is a view schematically showing how skew feeding correction is performed in a step in FIG. 4.

FIG. 6 is a view of a flowchart of a post-processing process executed by a finisher (post-processing apparatus) that constitutes the image forming system in FIG. 1.

FIG. 7A is a view showing an example of a state of a sheet A before it is passed through the fixing device.

FIG. 7B is a view showing an example of a state of a sheet B after it is passed through the fixing device.

FIG. 8 is a view schematically showing how skew feeding correcting is performed on a sheet.

FIG. 9 is a view illustrating states of a sheet before and after skew feeding correction is performed by a method according to the present invention, in a case where a skew of a leading edge of the sheet is produced by the fixing device.

### DESCRIPTION OF THE EMBODIMENTS

The present invention will now be described in detail below with reference to the accompanying drawings showing embodiments thereof.

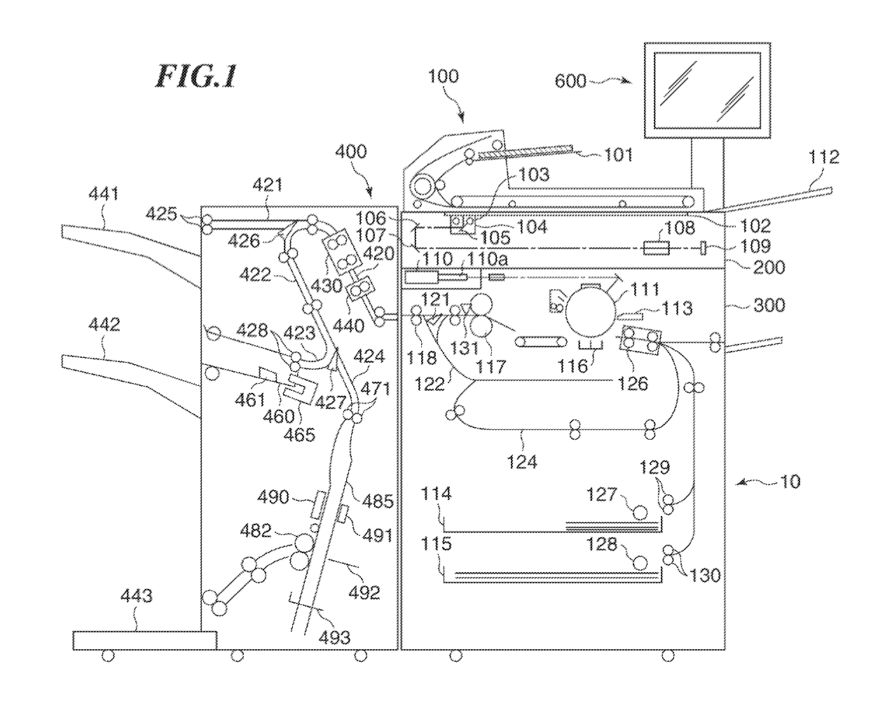

FIG. 1 is a schematic cross-sectional view of an image forming system according to an embodiment of the present invention. The image forming system comprises an image forming apparatus 10 that forms an image on a sheet by an electrophotographic method, and a finisher 400 which is an example of a post-processing apparatus for performing predetermined post-processing on a sheet having an image formed thereon by the image forming apparatus 10. The image forming apparatus 10 includes an operation and display unit 600, an image reader 200 for reading an image from an original, and a printer (print section) 300 for forming the image read from the original on a sheet.

The operation and display unit 600 is for inputting conditions for an image forming operation and post-processing, which a user desires to execute. A document feeder 100 is mounted on the image reader 200. The document feeder 100 sequentially feeds originals set on a document tray 101 with their front surfaces facing upward, one by one from the leading page, in the left direction, as viewed in FIG. 1, such that the originals are conveyed via a curved path through a reading position on a platen glass 102, from left to right, and then are discharged onto a discharge tray 112.

As each original passes the reading position from left to right on the platen glass 102, an image of the original is read by a scanner unit 104. Specifically, as the original passes the reading position, a light source 103 emits light toward the original, and reflected light from the original is guided to a lens 108 via mirrors 105, 106, and 107. Then, light having passed through the lens 108 forms an image on an imaging surface of an image sensor 109.

The image read from the original by the image sensor 109 is converted to image data, and is input as a video signal to an exposure controller 110 of the printer 300.

Note that an image of an original may be read by causing the document feeder 100 to convey the original on the platen glass 102 to stop the original at a predetermined position, and then causing the scanner unit 104 to scan the image from left to right in the stopped state of the original.

The exposure control section 110 of the printer 300 modulates a laser beam based on the video signal input from the image reader 200 and outputs the modulated laser beam. The laser beam output from the exposure control section 110 is irradiated onto a photosensitive drum 111 while being scanned by a polygon mirror 110a. On the photosensitive drum 111, an electrostatic latent image is formed according to the scanned laser beam. The electrostatic latent image formed on the photosensitive drum 111 is visualized as a developer image by a developer supplied from a developing device 113.

In the printer 300, a sheet is fed and conveyed from an upper cassette 114 or a lower cassette 115 mounted in the printer 300, by a conveying unit comprising a various types of rollers and the like. One of pickup rollers 127 and 128 feeds a sheet from an associated one of an upper cassette 114 and a lower cassette 115. Then, the sheet is conveyed to a skew correction unit 126 by an associated one of sheet feed roller pairs 129 and 130. The arrangement of the skew correction unit 126 will be described in detail hereinafter. The sheet undergoes skew feeding correction when it passes the skew correction unit 126 disposed in a conveying path. Then, the sheet is conveyed into between the photosensitive drum 111 and a transfer section 116 in timing synchronous with the start of the irradiation of the laser beam.

The developer image formed on the photosensitive drum 111 is transferred onto the sheet by the transfer section 116. The sheet having the developer image transferred thereon is conveyed to a fixing device 117. The fixing device 117 performs fixing processing for fixing the developer image on the sheet by heating and pressing the sheet. The sheet having undergone the fixing processing is conveyed such that it passes sheet detection sensors 131 and 132 (the sheet detection sensor 132 is not shown in FIG. 1) disposed in the conveying path at respective locations downstream of the fixing device 117.

The sheet passes a flapper 121 and a discharge roller pair 118 and is discharged from the printer 300 onto the finisher 400. When the sheet is to be discharged face-down, i.e. with an image-formed surface thereof facing downward, the sheet having passed the fixing device 117 is temporarily guided into an inversion path 122 by a switching operation of the flapper 121. Then, after the trailing edge of the sheet guided into the inversion path 122 has passed the flapper 121, the sheet is switched back to be inverted upside down, and is discharged from the printer 300 onto the finisher 400 by the discharge roller pair 118. Here, the flapper 121 and the inversion path 122 function as an inversion unit that inverts the sheet upside down by switching back the sheet. For example, when images are formed based on originals read using the document feeder 100 or when images are formed based on image data transferred from a personal computer, not shown, sheets are inverted by the flapper 121 and the inversion path 122, and hence the discharge roller pair 118 discharges the sheets in the correct page order (image formation order).

When image formation is performed on both sides of a sheet, after an image is formed on a first surface of the sheet, the sheet is guided into the inversion path 122 by a switching operation of the flapper 121. This causes the sheet to be inverted such that a portion of the sheet, which has been a trailing edge of the sheet during image formation on the first surface, becomes a leading edge of the sheet during image formation on a second surface of the sheet. After being inverted, the sheet is conveyed into a double-sided conveying path 124. The sheet guided into the double-sided conveying path 124 undergoes skew feeding correction in the skew correction unit 126 again, and then an image is formed on the second surface of the sheet.

The finisher 400 sequentially takes in sheets discharged from the printer 300 by a conveying unit (second conveying unit) comprising a various types of rollers and the like, and conveys the sheets through the conveying path, for performing various types of sheet post-processing on the sheets as required.

Examples of the sheet post-processing include alignment processing for aligning a plurality of sheets, staple processing for stapling the trailing end of a sheet bundle, punching processing for punching holes in the trailing end or its vicinity of a sheet, saddle-stitch processing, and so forth.

A punching unit 440 for punching holes in the trailing end or its vicinity of a sheet and a skew correction unit 430 for correcting skew feeding of a sheet are disposed at respective intermediate locations of an inlet path 420 of the finisher 400. The arrangement of the skew correction unit 430 is the same as that of the skew correction unit 126 disposed in the printer 300. The skew correction unit 430 corrects skew feeding of a sheet. The punching unit 440 operates as required to punch holes in a sheet of which the skew feeding has been corrected by the skew correction unit 430. After a sheet has passed the skew correction unit 126, when a position on the sheet away from the trailing edge by a predetermined distance toward the leading edge of the sheet has reached a position at which the punching unit 440 is to punch holes in the sheet, the punching unit 440 stops the sheet to punch holes therein.

At a location downstream of the inlet path 420, there is disposed a switching flapper 426 for guiding sheets into a non-sorting path 421 or a sorting path 422. The sheets guided into the non-sorting path 421 are discharged onto a sample tray 441 via a conveying roller pair 425. Further, at a location downstream of the sorting path 422, there is disposed a switching flapper 427 for guiding sheets into a sorting discharge path 423 or a bookbinding path 424. The sheets guided into the sorting discharge path 423 are stacked on an intermediate tray 460 via a conveying roller pair 428.

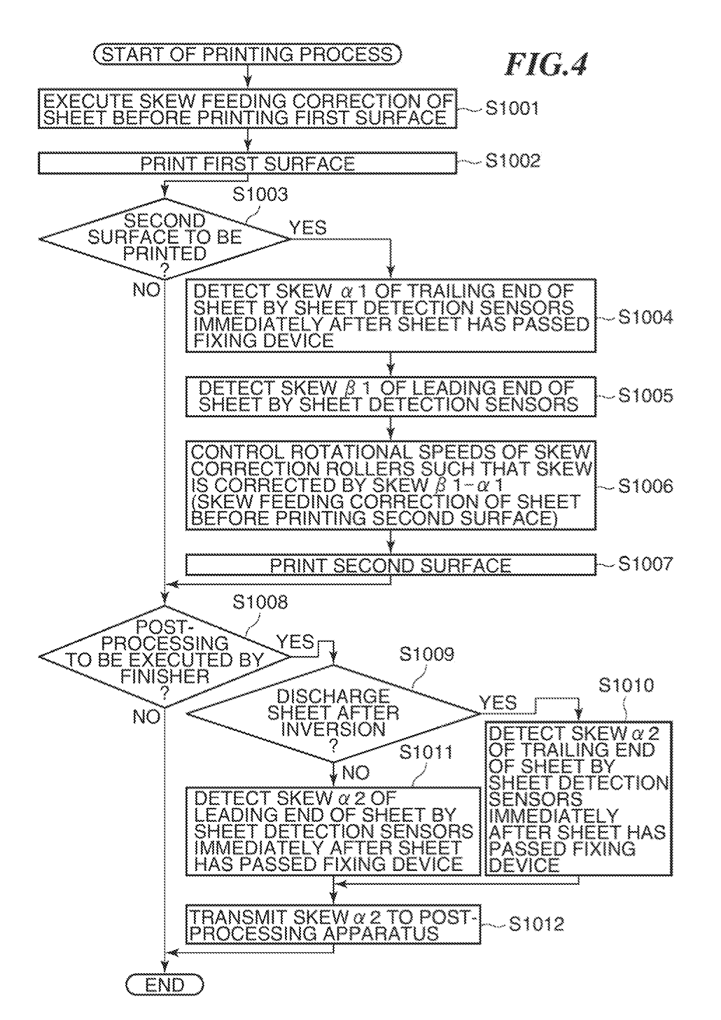

A pair of alignment members 461 arranged in a direction orthogonal to a sheet conveying direction performs the alignment processing on the sheets stacked on the intermediate tray 460. Then, a stapler 465 movably disposed along the outer periphery of the intermediate tray 460 performs the staple processing on the sheets stacked on the intermediate tray 460. A bundle of the sheets having undergone the staple processing is discharged onto a stack tray 442 by a discharge roller (not shown). Note that the stapler 465 binds sheets in the trailing end (rear end) thereof with respect to the sheet conveying direction (left direction, as viewed in FIG. 4).

Further, the sheet guided into the bookbinding path 424 is conveyed to a bookbinding processing tray 485 via a conveying roller pair 471. In the bookbinding processing tray 485, there is provided a sheet positioning member 493 of a movable type. The sheet positioning member 493 moves up and down to set sheets at a predetermined position according to the size thereof. Furthermore, the bookbinding processing tray 485 includes a stapler 490 and an anvil 491 disposed at a location opposed to the stapler 490. The stapler 490 and the anvil 491 cooperate to perform staple processing on a bundle of sheets received in the bookbinding processing tray 485.

A folding roller pair 482 and a thrusting member 492 are disposed downstream of the staplers 490. The thrusting member 492 is caused to protrude toward a sheet bundle received in the bookbinding processing tray 485, whereby the sheet bundle is pushed in between the folding roller pair 482. The folding roller pair 482 rotates in a manner drawing in the sheet bundle to thereby fold the sheet bundle and conveys the same to a bookbinding tray 443.

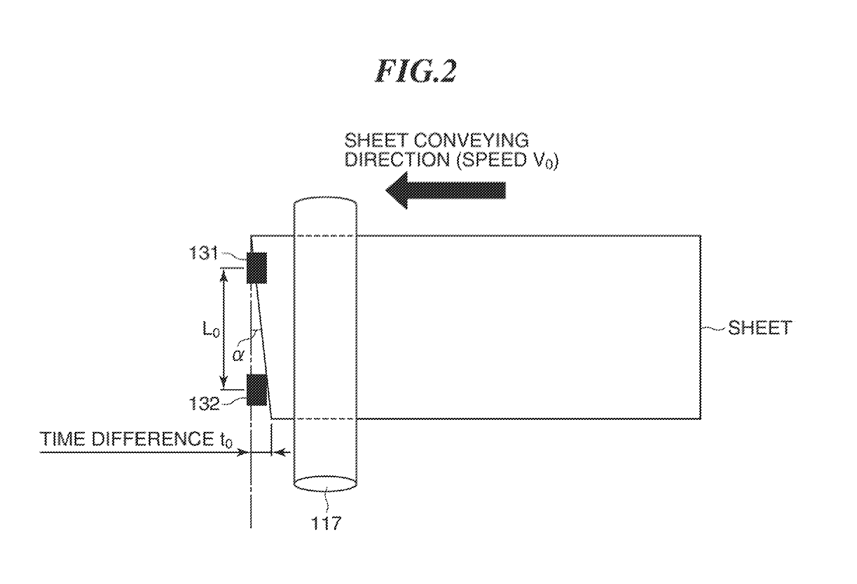

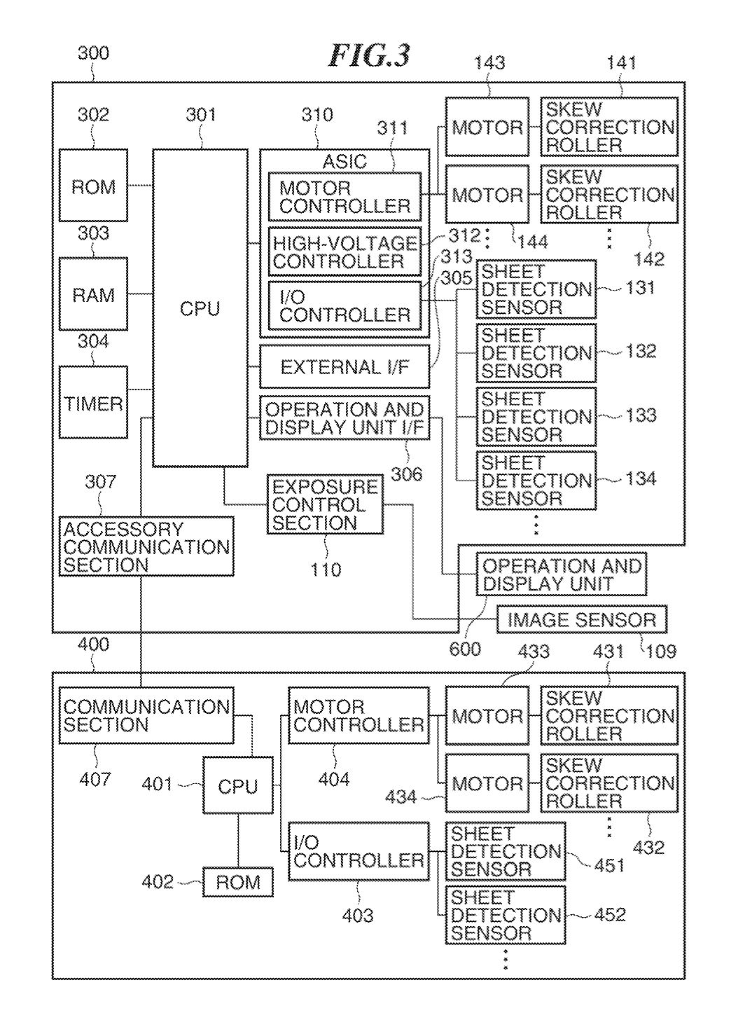

FIG. 2 is a schematic plan view of sheet detection sensors 131 and 132 for detecting whether or not there is a sheet having passed the fixing device 117. The sheet detection sensors 131 and 132 in respective second locations downstream of the fixing device 117 are arranged in a manner spaced by a predetermined distance in the direction orthogonal to the sheet conveying direction. The sheet detection sensors 131 and 132 function as a first skew detection sensor. Note that each of the sheet detection sensors 131 and 132 comprises a light emitter and a light receiver provided at a position for receiving reflected light from a sheet irradiated with light from the light emitter. Each of the sheet detection sensors 131 and 132 continues to output a high-level signal while the light receiver is receiving reflected light from the sheet. A CPU 301 (FIG. 3) detects a skew of the leading edge of the sheet based on a time difference t₀ between timing in which the sheet detection sensor 131 outputs the high-level signal and timing in which the sheet detection sensor 132 outputs the high-level signal. More specifically, assuming that the conveying speed of the sheet is represented by V₀, and the distance between the sheet detection sensors 131 and 132 is represented by L₀, the skew α of the leading edge of the sheet is calculated by the equation of α=tan⁻¹(V₀×t₀/L₀)[=arc tan(V₀×t₀/L₀)]. That is, the CPU 301 (FIG. 3) detects the skew α of the leading edge of the sheet based on timing in which the leading edge of the sheet reaches the sheet detection sensor 131 and timing in which the leading edge of the sheet reaches the sheet detection sensor 132. Here, the above-described time difference t₀ corresponds to second information. Further, the sheet detection sensors 131 and 132 function as a second acquisition unit that acquires the second information concerning the skew α of a leading end of the sheet, which is changed due to passing of the sheet through the fixing device 117. Note that the sheet detection sensor 131 corresponds to a third sensor, and the sheet detection sensor 132 corresponds to a fourth sensor.

Further, the CPU 301 (FIG. 3) detects a skew α1 of the trailing edge of the sheet based on a time difference between timing in which the sheet detection sensor 131 outputs a low-level signal after outputting the high-level signal and timing in which the sheet detection sensor 132 outputs a low-level signal after outputting the high-level signal. That is, the CPU 301 (FIG. 3) detects the skew α1 of the trailing edge of the sheet based on timing in which the trailing edge of the sheet passes the sheet detection sensor 131 and timing in which the trailing edge of the sheet passes the sheet detection sensor 132. Here, the time difference corresponds to the second information. Note that the skew α1 of the trailing edge of the sheet corresponds to the skew α of the leading edge of the sheet conveyed to the transfer section 116 since the sheet is inverted upside down by switchback, described hereinafter.

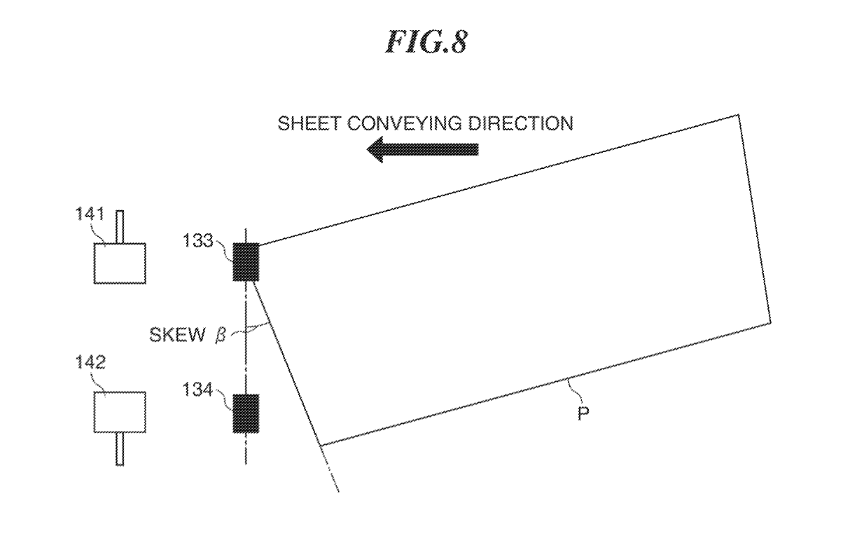

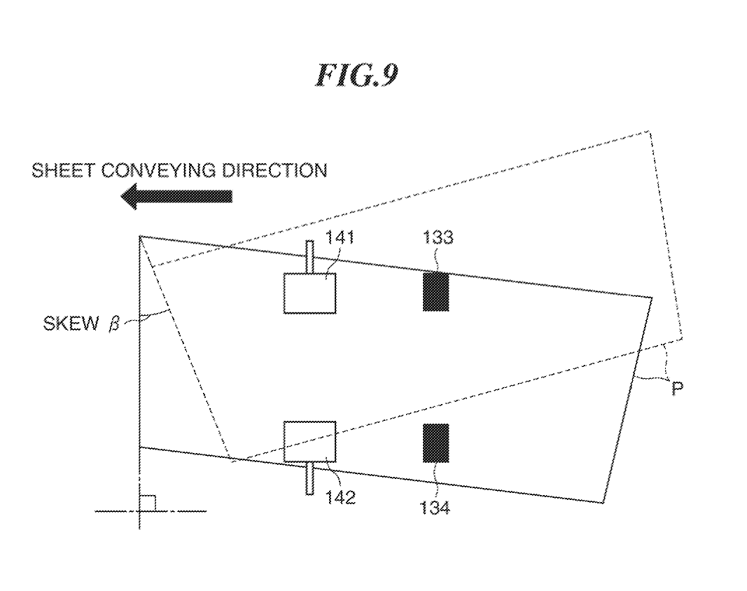

The skew correction unit 126 has the same arrangement as described hereinabove with reference to FIGS. 8 and 9. The skew correction unit 126 is disposed at a first position upstream of the transfer section 116 in the sheet conveying direction. The skew correction unit 126 includes the skew correction rollers 141 and 142 which are arranged in a manner spaced in the direction orthogonal to the sheet conveying direction by a predetermined distance and of which the rotational speeds can be controlled independently of each other. Further, the skew correction unit 126 includes the sheet detection sensors 133 and 134 as first skew detection sensors which are arranged in a manner spaced in the direction orthogonal to the sheet conveying direction by a predetermined distance.

Each of the sheet detection sensors 133 and 134 comprises a light emitter and a light receiver provided at a position for receiving reflected light from a sheet irradiated with light from the light emitter. If the sheet is not at a position from which the light emitter emits light (measurement position), the light receiver cannot receive reflected light from the sheet. Each of the sheet detection sensors 133 and 134 continues to output a high-level signal while the light receiver is receiving reflected light from the sheet. The skew correction unit 126 is capable of determining the skew β of the leading edge of the sheet by the same method as employed in the above-described sheet detection sensors 131 and 132. That is, the skew β of the leading edge of the sheet is detected based on timing in which the leading edge of the sheet reaches a third position at which the sheet detection sensor 133 detects the sheet and timing in which the leading edge of the sheet reaches a fourth position at which the sheet detection sensor 134 detects the sheet. More specifically, based on a time difference t₁ between timings in which the sheet detection sensors 133 and 134 detect a sheet, a conveying speed V₁ of the sheet, and a distance L₁ between the sheet detection sensors 133 and 134, the skew β is calculated by the equation of β=tan⁻¹(V₁×t₁/L₁). Here, the above-mentioned time difference t₁ corresponds to first information. Further, the sheet detection sensors 133 and 134 function as a first acquisition unit that acquires the first information concerning the skew β of a leading end of the sheet. Note that the sheet detection sensor 133 corresponds to a first sensor, and the sheet detection sensor 134 corresponds to a second sensor.

The skew correction unit 126 corrects skew feeding of a sheet by controlling the rotational speeds of the skew correction rollers 141 and 142 independently of each other, based on the skew β detected by the sheet detection sensors 133 and 134 and the skew α detected by the sheet detection sensors 131 and 132. More specifically, after the sheet detection sensors 133 and 134 detect the skew β of the leading edge of the sheet, the skew correction unit 126 controls the rotational speeds of the two skew correction rollers 141 and 142 independently of each other such that the skew feeding is corrected by a difference β−α between the skews of the sheet passing the skew correction unit 126, by taking into account the skew α of the sheet caused by expansion or contraction of the sheet having passed the fixing device 117. In other words, after the sheet detection sensors 133 and 134 detect the skew β of the leading edge of the sheet, the skew correction unit 126 controls the attitude of the sheet such that the skew of the leading edge of the sheet in the direction orthogonal to the sheet conveying direction becomes equal to an angle equal to the skew α, by causing the skew correction rollers 141 and 142 to rotate independently of each other.

Note that the skew correction unit 126 corrects the skew feeding of the sheet by the skew β−α of the sheet during printing of a second surface of the sheet in a case where double-sided printing is performed. Further, the skew correction unit 126 corrects the attitude of the sheet during printing of a first surface of the sheet such that the skew β of the leading edge of the sheet detected by the sheet detection sensors 133 and 134 becomes equal to 0.

Further, similarly to the skew correction unit 126, the skew correction unit 430 (FIG. 1) provided in the finisher 400 includes skew correction rollers 431 and 432 (FIG. 3) driven independently of each other, and sheet detection sensors 451 and 452. The sheet detection sensors 451 and 452 are configured similarly to the sheet detection sensors 133 and 134. Since the skew correction unit 430 performs the skew feeding correction by the same method as employed in the skew correction unit 126, detailed description thereof is omitted. Note that the skew correction unit 126 corrects the skew feeding of the sheet by the skew β−α of the sheet after a first surface of a sheet is printed in the case of single-sided printing, and after a second surface of a sheet is printed in the case of double-sided printing.

FIG. 3 is a block diagram of the control system of the image forming system in FIG. 1. The printer 300 comprises the CPU 301, a ROM 302, a RAM 303, a timer 304, an external interface 305, an operation and display section interface 306, an accessory communication section 307, the exposure control section 110, and an ASIC (application specific integrated circuit) 310.

The CPU 301 controls the overall operation of the printer 300. The ROM 302 stores programs, parameters, sequences, and so forth required for control operations by the CPU 301. The RAM 303 is used as a system working memory. The external interface 305 communicates with an external apparatus (not shown), such as a personal computer. The operation and display unit interface 306 receives user inputs from the operation and display unit 600. The accessory communication section 307 communicates with an external sheet feeder and discharger. In the present embodiment, the accessory communication section 307 communicates with the finisher 400.

The ASIC 310 comprises a motor controller 311, a high-voltage controller 312, and an input/output (I/O) controller 313. The motor controller 311 controls the driving of each of a plurality of motors for rotating the various conveying rollers used in the image forming apparatus 10. That is, the motor controller 311 controls the rotational speed and rotating direction of each motor to thereby control the rotational speed and rotating direction of an associated one of the conveying rollers. FIG. 3 illustrates motors 143 and 144 for driving the skew correction rollers 141 and 142 for rotation.

The high-voltage controller 312 controls high voltage for development, charging, transfer, etc. The input and output controller 313 controls inputs and outputs to and from various types of sensors and the like. A plurality of sensors are connected to the input and output controller 313, and the input and output controller 313 transmits sensor signals output from the sensors to the CPU 301. FIG. 3 illustrates the sheet detection sensors 131 and 132 and the sheet detection sensors 133 and 134 as examples of the sensors.

The finisher 400 comprises a CPU 401, a ROM 402, an input/output (I/O) controller 403, a motor controller 404, and a communication section 407. The CPU 401 controls the overall operation of the finisher 400 according to commands from the CPU 401. The ROM 402 stores programs, sequences, and so forth required for control operations by the CPU 401.

A plurality of sensors are connected to the input and output controller 403, and the input and output controller 403 transmits sensor signals output from the sensors to the CPU 401. FIG. 3 illustrates the sheet detection sensors 451 and 452 as examples of the sensors. The motor controller 404 controls the driving of each of a plurality of motors for rotating the various conveying rollers used in the finisher 400. That is, the motor controller 404 controls the rotational speed and rotating direction of each motor to thereby control the rotational speed and rotating direction of an associated one of the conveying rollers. FIG. 3 illustrates motors 433 and 434 for driving the skew correction rollers 431 and 432 for rotation. The communication section 407 is capable of communicating with the CPU 301 of the printer 300 via the accessory communication section 307.

FIG. 4 is a flowchart of a printing process executed by the image forming apparatus 10. Steps of the printing process shown in the flowchart are executed by the CPU 301 by reading out a program required therefor from the ROM 302, loading the program in a work area of the RAM 303, and executing the same, and thereby controlling operations of driving elements and the like that form the image forming apparatus 10.

First, the CPU 301 corrects skew feeding of a sheet before printing a first surface of the sheet (step S1001). In the step S1001, the skew α has not been detected by the sheet detection sensors 131 and 132 yet, and hence the skew feeding correction is performed based on the skew β detected by the sheet detection sensors 133 and 134. Then, the CPU 301 transfers a developer image formed by reading an original using the document feeder 100 or a developer image formed based on image data transferred from a personal computer, not shown, onto the first page of the sheet (step S1002). Next, the CPU 301 determines whether or not a second surface is to be printed (whether or not double-sided printing is to be performed) (step S1003). If the second surface is not to be printed (NO to the S1003), the CPU 301 proceeds to a step S1008, referred to hereinafter.

On the other hand, if the second surface is to be printed (YES to the S1003), the CPU 301 detects the skew α1 of the trailing edge of the sheet immediately after the sheet having the developer image transferred onto the first surface thereof has passed the fixing device 117, based on the signals output from the sheet detection sensors 131 and 132 (step S1004). Then, the CPU 301 detects the skew β1 of the leading edge of the sheet based on the high-level signals output from the respective sheet detection sensors 133 and 134 when the sheet is passing the skew correction unit 126 after having been conveyed on the double-sided conveying path 124 (step S1005). Here, the trailing edge of the sheet of which the skew α1 has been detected in the step S1004 has become the leading edge of the sheet when it is conveyed into the double-sided conveying paths 124.

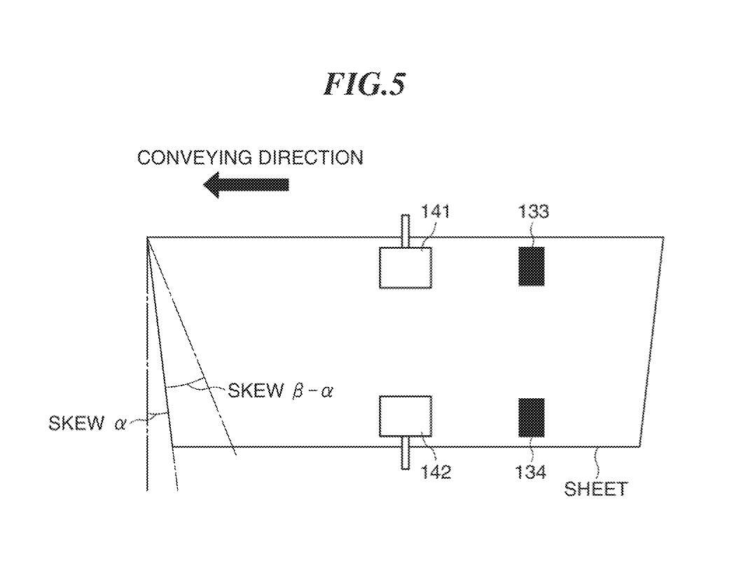

Then, the CPU 301 corrects skew of the sheet having undergone the fixing processing by taking into account the difference between the amounts of expansion or contraction of the sheet at respective positions in the direction of width thereof, caused by the fixing processing during printing of the first surface. The CPU 301 corrects the skew feeding of the sheet by controlling the rotational speeds of the respective skew correction rollers 141 and 142 independently of each other, such that the skew is corrected by a skew β1−α1 of the sheet (step S1006). FIG. 5 schematically shows how skew feeding correction is performed in the step S1006. Next, the CPU 301 prints the second surface of the sheet (step S1007), and then the process proceeds to the step S1008.

In the step S1008, the CPU 301 determines whether or not the finisher 400 is set to perform post-processing on the sheet. If it is determined in the step S1008 that the finisher 400 is not set to perform post-processing on the sheet, the CPU 301 discharges the sheet onto the sample tray 441 of the finisher 400.

On the other hand, if it is determined in the step S1008 that the finisher 400 is set to perform post-processing on the sheet, the CPU 301 determines whether or not the sheet is to be discharged after being inverted upside down (step S1009). If it is determined in the step S1009 that the sheet is to be inverted upside down, the CPU 301 detects a skew α2 of the trailing edge of the sheet immediately after the sheet has passed the fixing device 117, based on the low-level signals output from the sheet detection sensors 131 and 132 (step S1010).

On the other hand, if it is determined in the step S1009 that the sheet is not to be inverted upside down, the CPU 301 detects a skew α2 of the leading edge of the sheet immediately after the sheet has passed the fixing device 117, based on the high-level signals output from the respective sheet detection sensors 131 and 132 (step S1011). Note that in the steps S1010 and 1011, the skew of an edge which is to be the leading edge of the sheet when conveyed into the finisher 400 is detected as the skew α2, and hence the edge for detection of the skew is different between the steps S1010 and S1011.

Next, the CPU 301 transmits the skew α2 detected in the step S1010 or S1011 to the CPU 401 of the finisher 400 (step S1012), followed by terminating the printing process performed by the image forming apparatus 10. Note that although in FIG. 4, the printing process is performed on one sheet, when the printing process is performed on a plurality of sheets, the above-described printing process is repeatedly performed.

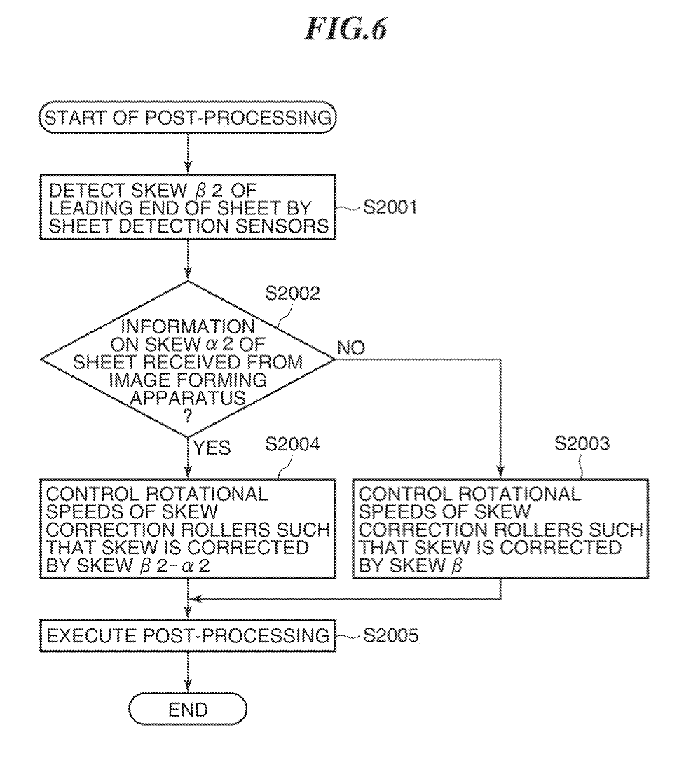

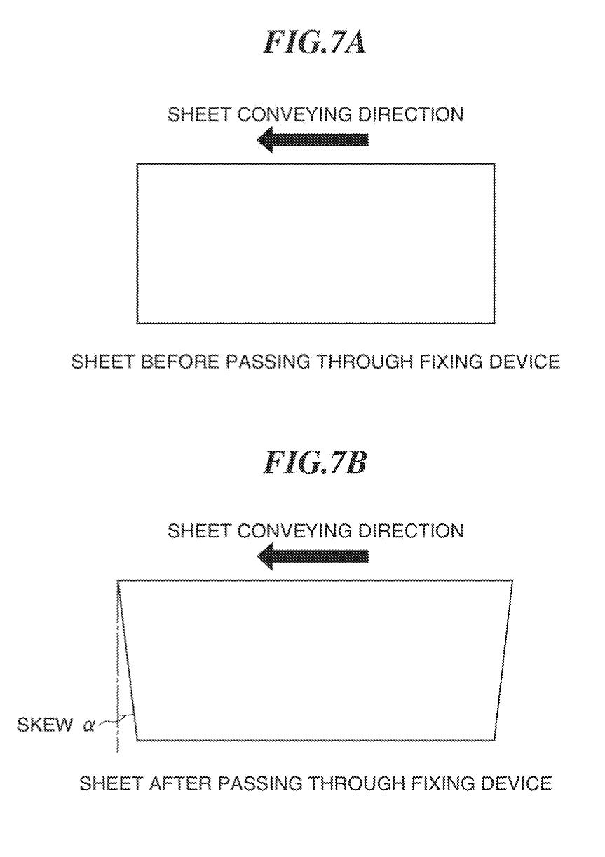

FIG. 6 is a flowchart of post-processing process executed by the finisher 400. Steps of the post-processing process shown in the flowchart are executed by the CPU 401 by reading out a program or the like required therefor from the ROM 402, and executing the same.

Then, the CPU 401 detects a skew β2 of the leading edge of the sheet conveyed to the skew correction unit 430, based on the high-level signals output from the respective sheet detection sensors 451 and 452 (step S2001). The CPU 401 determines whether or not information on the skew α2 of the sheet has been received from the CPU 301 (step S2002).

If it is determined in the step S2002 that the information on the skew α2 of the sheet has not been received from the CPU 301, the CPU 401 controls the rotational speeds of the respective skew correction rollers 431 and 432 of the skew correction unit 430 such that the skew β2 of the sheet becomes equal to 0 (step S2003).

On the other hand, if it is determined in the step S2002 that the information on the skew α2 of the sheet has been received from the CPU 301, the CPU 401 controls the rotational speeds of the respective skew correction rollers 431 and 432 of the skew correction unit 430 such that the skew β2 of the sheet becomes equal to an angle of the skew α2 (step S2004). This makes it possible to accurately correct the skew of the sheet having passed the fixing device 117 by taking into account the expansion or contraction of the sheet caused by the fixing processing in the image forming apparatus. Then, the CPU 401 executes required post-processing (post-processing set by the operation and display unit 600) (step S2005), followed by terminating the post-processing process.

Further, although in the present embodiment, to acquire information concerning the skew of the leading edge and/or the trailing edge of a sheet, the image forming apparatus is configured to use the sheet detection sensors 131 and 132, the sheet detection sensors 133 and 134, and the sheet detection sensors 451 and 452, the method for acquiring information concerning the skew of the leading edge or the trailing edge of a sheet is not limited to the above configuration. To acquire information concerning the skew of the leading edge or the trailing edge of a sheet, there may be provided e.g. image sensor units including image sensor devices, such as CMOS (complementary metal oxide semiconductor) image sensors, in place of the sheet detection sensors 131 and 132. In this configuration, by analyzing an image picked up in timing in which the leading edge or the trailing edge of the sheet reaches a shooting position, it is possible to acquire the information concerning the skew of the leading edge or trailing edge of the sheet. In this case, the image sensor unit provided in the skew correction unit 126 corresponds to a first acquisition unit that acquires an image of a leading end of the sheet as first information concerning the skew of the leading end of the sheet. Further, the image sensor unit provided in place of the sheet detection sensors 131 and 132 correspond to a second acquisition unit that acquire an image of a trailing end of the sheet as second information concerning the skew of a edge that becomes the leading edge of the sheet before being conveyed in the transfer section 116 that is to transfer an image on the second surface of the sheet.

Further, the information concerning the skew of the leading edge or trailing edge of the sheet may be acquired by an image sensor unit that is formed by a plurality of CCD (charge coupled device) sensors arranged in the direction orthogonal to the sheet conveying direction.

Further, although in the present embodiment, a sheet is inverted upside down by switchback, the configuration for inverting the sheet upside down is not limited to this. For example, the sheet may be inverted upside down by passing the sheet through a spiral conveying path.

As described heretofore, according to the present embodiment, since skew feeding of a sheet is corrected by taking into account the expansion or contraction of the sheet caused by the fixing processing, it is possible to accurately correct the skew of the sheet. This makes it possible to perform accurate printing without displacement of an image with respect to the sheet when a second surface is printed. Further, in the post-processing by the finisher 400, it is possible to minimize variation in the skew of the sheet, thereby making it possible to a high-quality post-processed product.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

This application claims priority from Japanese Patent Application No. 2011-134303 filed Jun. 16, 2011, and Japanese Patent Application No. 2012-124394 filed May 31, 2012, which are hereby incorporated by reference herein in their entirety.

What is claimed is:

1. An image forming apparatus comprising:
a transfer unit configured to transfer an image onto a sheet;
a first acquisition unit configured to acquire first information on a skew of a leading end of the sheet at a first position upstream of said transfer unit in a sheet conveying direction;
a correction unit configured to correct an attitude of the sheet based on the first information acquired by said first acquisition unit;
a fixing unit configured to fix an image transferred onto the sheet by said transfer unit, on the sheet;
an inversion unit configured to invert, after an image is fixed on a first surface of a sheet by said fixing unit, the sheet upside down in order to transfer an image onto a second surface of the sheet; and
a second acquisition unit configured to acquire second information on a skew of an end of the sheet at a second position downstream of said fixing unit in the sheet conveying direction, the end of the sheet being the leading end of the sheet after the sheet is inverted upside down by said inversion unit,
wherein when an image is transferred onto the second surface of a sheet, said correction unit corrects an attitude of the sheet based on the second information acquired by said second acquisition unit, and the first information, acquired by said first acquisition unit, on a skew of a leading end of the sheet which has been inverted upside down by said inversion unit.

2. The image forming apparatus according to claim 1, wherein said first acquisition unit includes a first sensor and a second sensor for detecting a sheet,
wherein said first sensor and said second sensor are arranged at respective locations different from each other in a direction orthogonal to the sheet conveying direction, and
wherein said first acquisition unit acquires the first information based on a signal output from said first sensor and a signal output from said second sensor.

3. The image forming apparatus according to claim 1, wherein said first acquisition unit includes an image sensor that takes an image of a sheet at the first position, and
wherein said first acquisition unit acquires the first information based on the image of the sheet taken by said image sensor.

4. The image forming apparatus according to claim 1, wherein said second acquisition unit includes an image sensor that takes an image of the sheet at the second position, and
wherein said second acquisition unit acquiring the second information based on the image of the sheet taken by said image sensor.

5. The image forming apparatus according to claim 4, wherein said inversion unit inverts a sheet having an image transferred onto the first surface thereof, upside down, by switching back the sheet after the sheet has passed through said fixing unit, and
wherein said second acquisition unit acquires the second information based on an image of a trailing end of the sheet taken by said image sensor.

6. The image forming apparatus according to claim 1, wherein said second acquisition unit includes a third sensor and a fourth sensor for detecting the sheet,
wherein said third sensor and said fourth sensor are arranged at respective locations different from each other in a direction orthogonal to the sheet conveying direction, and
wherein said second acquisition unit acquires the second information based on a signal output from said third sensor and a signal output from said fourth sensor.

7. The image forming apparatus according to claim 6, wherein said inversion unit inverts a sheet having an image transferred onto the first surface by switching back after the sheet has passed through said fixing unit, and
wherein said second acquisition unit acquires the second information, based on timing in which said third sensor outputs a signal indicating that said third sensor detects no sheet after detecting the sheet, and timing in which said fourth sensor outputs a signal indicating that said fourth sensor detects no sheet after detecting the sheet, before said inversion unit inverts the sheet upside down.

8. The image forming apparatus according to claim 1, wherein said inversion unit inverts a sheet having an image transferred onto the first surface by switching back after the sheet has passed through said fixing unit, and
wherein said second acquisition unit acquires the second information based on a result of detection of a skew of a trailing end of the sheet before said inversion unit inverts the sheet upside down.

9. An image forming system comprising:
a transfer unit configured to transfer an image onto a sheet;
a fixing unit configured to fix the image transferred onto the sheet by said transfer unit on the sheet;
a post-processing unit configured to perform post-processing on the sheet after the image is fixed on the sheet by said fixing unit;
a first acquisition unit configured to acquire first information on a skew of a leading end of the sheet having passed said fixing unit, at a first position downstream of said fixing unit and upstream of said post-processing unit in a sheet conveying direction;
a second acquisition unit configured to acquire second information on the skew of the leading end of the sheet at a second position downstream of the first position and upstream of said post-processing unit in the sheet conveying direction; and
a correction unit configured to correct an attitude of the sheet based on the first information acquired by said first acquisition unit and the second information acquired by said second acquisition unit.

10. The image forming system according to claim 9, wherein said first acquisition unit includes a first sensor and a second sensor for detecting the sheet,
wherein said first sensor and said second sensor are arranged at respective locations different from each other in a direction orthogonal to the sheet conveying direction, and
wherein said first acquisition unit acquires the first information based on a signal output from said first sensor and a signal output from said second sensor.

11. The image forming system according to claim 9, wherein said second acquisition unit includes a third sensor and a fourth sensor for detecting the sheet,
wherein said third sensor and said fourth sensor are arranged at respective locations different from each other in a direction orthogonal to the sheet conveying direction, and
wherein said second acquisition unit acquires the second information based on timing in which said third sensor detects the sheet and timing in which said fourth sensor detects the sheet.

12. The image forming system according to claim 9, wherein said first acquisition unit includes an image sensor that takes an image of the sheet at the first position, and
wherein said first acquisition unit acquires the first information based on an image of a leading end of the sheet taken by said image sensor.

13. The image forming system according to claim 9, wherein said second acquisition unit includes an image sensor that takes an image of the sheet at the second position, and
wherein said second acquisition unit acquires the second information based on an image of a leading end of the sheet taken by said image sensor.

14. The image forming system according to claim 10, further comprising an inversion unit configured to invert, after said fixing unit fixes an image on a sheet, the sheet upside down, by switching back the sheet, and
wherein said first acquisition unit acquires the first information, based on timing in which said first sensor outputs a signal indicating that said first sensor detects no sheet after detecting the sheet, and timing in which said second sensor outputs a signal indicating that said second sensor detects no sheet after detecting the sheet, before said inversion unit inverts the sheet upside down.

15. The image forming system according to claim 12, further comprising an inversion unit configured to invert, after said fixing unit fixes an image on a sheet, the sheet upside down, by switching back the sheet, and
wherein said first acquisition unit acquires, before the sheet is inverted by said inversion unit, the first information on a skew of an end that is to become the leading end of the sheet in the sheet conveying direction in which the sheet is conveyed to said post-processing unit in a case where said post-processing unit performs the post-processing on the sheet, based on an image of a trailing end of the sheet taken by said image sensor.

16. A post-processing apparatus that performs post-processing on a sheet on which an image has been formed by an image forming apparatus, comprising:
a reception unit configured to receive first information transmitted from the image forming apparatus including a fixing unit configured to fix an image formed on a sheet, on the sheet, the first information being information on a skew of a leading end of the sheet on which the image has been fixed by the fixing unit;
a post-processing unit configured to perform post-processing on the sheet supplied from the image forming apparatus;
an acquisition unit configured to acquire second information on a skew of the leading end of the sheet supplied from the image forming apparatus, at a position upstream of said post-processing unit;
a correction unit configured to correct an attitude of the sheet based on the first information received by said reception unit and the second information acquired by said acquisition unit.

17. The post-processing apparatus according to claim 16, wherein said acquisition unit includes a first sensor and a second sensor for detecting the sheet,
wherein said first sensor and said second sensor are arranged at respective locations different from each other in a direction orthogonal to a sheet conveying direction, and
wherein said acquisition unit acquires the second information based on timing in which said first sensor detects the sheet and timing in which said second sensor detects the sheet.

18. The post-processing apparatus according to claim 16, wherein said acquisition unit includes an image sensor that takes an image of the sheet at the position upstream of said post-processing unit, and
wherein said acquisition unit acquires the second information based on an image of the leading end of the sheet taken by said image sensor.
